(19) United States
(12) Patent Application Publication
(10) Pub. No.: US 2008/0298240 A1
(43) Pub. Date: Dec. 4, 2008

(54) NODE AVAILABILITY PREDICTION-BASED GRID NETWORK CONGESTION CONTROL DEVICE AND METHOD THEREFOR

(75) Inventors: Jong Sik LEE, Incheon (KR); Sung Ho JANG, Incheon (KR)

Correspondence Address: Jefferson IP Law, LLP, 1730 M Street, NW, Suite 807, Washington, DC, 20036, US

(73) Assignee: Industry Collaboration Foundation of INHA UNIVERSITY, Incheon (KR)

(21) Appl. No.: 11/964,354

(22) Filed: Dec. 26, 2007

(30) Foreign Application Priority Data
Jun. 1, 2007 (KR) 10-2007-0053763

(51) Int. Cl. G08C 15/00

(52) U.S. Cl. 370/235

(57) ABSTRACT

A system and method are disclosed, which controls congestion to efficiently transmit data through a network of grid node network in a grid computing environment where a large amount of data is processed. The system and method are performed in such a way that, according to a grid application program's request for distributed processing a large amount of data, the data is divided into packets, the node availability of respective nodes distributed in the grid network is measured with consideration to the bandwidth and the queue size of available grid nodes to avoid and control network congestion that may occur when the packets are processed by distributed processing using the respective nodes, the average node availability of all nodes is predicted using a statistical method, a threshold is calculated based on the predicted average node availability to set a dynamic congestion area representing the congestion level of the respective nodes, and the amount of packet transmission is controlled based on the congestion area. As the grid nodes are managed by controlling congestion, packet loss and packet delay are reduced and the rate of packet processing and the rate of node use are increased. Therefore, data can be stably transmitted to the grid user through the network with an improvement in the Quality of Service (QoS).

### PRIORITY

This application claims the benefit under 35 U.S.C. § 119(a) of a Korean patent application filed on Jun. 1, 2007 in the Korean Intellectual Property Office and assigned Serial No. 10-2007-0053763, and the entire disclosure of which is hereby incorporated by reference

### BACKGROUND OF THE INVENTION

1. Field of the Invention

The present invention generally relates to grid computing systems. More particularly, the present invention relates to a system and method for controlling congestion in a grid network of nodes, which can efficiently transmit data in a grid-computing environment where a large amount of data is processed.

2. Description of the Related Art

Congestion in a grid network represents the situation where the traffic or equipment present in the grid network exceeds the available network capacity. This congestion causes packets to be delayed. If this congestion continues, then data packets form a queue. This causes a queuing delay. As a result, the congestion causes packet loss and data loss with packet delay.

More specifically, since packet allocation and communication are frequently performed between a grid administrator and respective grid nodes, which have a variety of bandwidths and limited storage devices, in a grid network, there is a relatively high possibility of congestion. Here, the grid network allows a large amount of data requested by a grid application program to be transmitted and processed.

A Transmission Control Protocol (TCP) as the transmission protocol usually used in a grid network discards packets at random, which are allocated in excess of the limit value if the grid node is in a congested state. On the contrary, if the grid node isn't in a congested state, the TCP allows packets corresponding to the discarded packets to be re-transmitted using a packet re-transmission mechanism. This increases the response time which causes data processing delays and makes the network unstable.

In order to resolve these problems, an additional network congestion control system needs to be adapted to the grid network. The following describes conventional network congestion control techniques that have been studied to date.

Wu Liu, Hai-Xin Duan, Jianping Wu, Xing Li, and Ping Ren's (hereinafter referred to as Wu Liu, et al.) “Algorithms for Congestion Detection and Control” in LNCS 3252, pp. 374˜381, describes the Early Congestion Detection & Control gateway (ECDC) and a congestion control method for congestion avoidance and congestion control.

Wu Liu, et al.'s method performs congestion avoidance and congestion control in such a way that the average queue size of the respective nodes is calculated, and, if the respective nodes exceed a threshold, packets are discarded or the bits of the header in the packets are set. However, since Wu Liu, et al.'s method utilizes only the present measurement value based on a single parameter to control congestion, the congestion presently generated may subsequently occur again.

Also, P. Dickens presents “FOBS: A lightweight communication protocol for Grid Computing” in LNCS 2790, pp. 938˜946, in which the lightweight communication protocol provides a user-level communication mechanism for transmitting a large amount of data of computational grids, and an aggressive congestion control method. Dickens' method employs the packet loss rate to control congestion, similar to the conventional TCP congestion control method, and, if the packet loss rate exceeds the threshold, reduces the transmission rate to avoid congestion in the network.

However, since Dickens' method determines the network congestion state based on the packet loss rate that is taken into account after the packet loss occurs, it has difficulty detecting and avoiding the initial congestion.

Additionally, a conventional congestion control method has been disclosed in Korean Patent Publication No. 10-2005-0071403.

These conventional network congestion control techniques control congestion in the network based on the size of priority queues for storing packets located at the nodes, or the size of congestion window. Although these conventional techniques may be relatively suitable for controlling the network congestion that is generated due to the bottleneck phenomena in a conventional network environment whose performance is limited, they require numerous grid nodes and thus are not appropriate for a grid network environment where a relatively large bandwidth is needed and a high network delay occurs.

These conventional network congestion control techniques have a disadvantage in that the size of priority queues or the size of congestion window, which is used to set the congestion reference, is not sufficient to express the degree of congestion for a network of grid nodes, including various reference parameters, such as a bandwidth and idle channel, etc. Also, since the conventional techniques must frequently perform communication to measure congestion-related parameters, in real time, and thus cause network delays, they cannot cope with a grid node state that alters according to elapsed time and increased workload. In addition, since conventional techniques use the statistical critical values, they have difficulty reacting to dynamic changes in a grid node. Especially, if network workload is low, the conventional techniques do not sufficiently use the bandwidth of the network. Furthermore, these conventional techniques are disadvantageous in that packet loss increases and node use rate decreases since an aggressive congestion control mechanism discards packets of corresponding nodes when the amount of communication for real time measurement is increased and network congestion occurs.

### SUMMARY OF THE INVENTION

An aspect of the present invention is to address at least the above-mentioned problems and to provide at least the advantages described below. Accordingly, an aspect of the present invention is to provide a system and method for controlling grid network congestion that detects and controls congestion in a grid network that includes a relatively high bandwidth and a relatively high network delay to transmit data stably and reliably through the grid network thereby reducing packet loss and packet delay.

Another aspect of the present invention is to provide a system and method for controlling grid network congestion that enhances the node use rate to improve the amount of packets processed through a packet adjusting unit that divides a large amount of data transmitted from a grid application program into packets to comply with the performance of the grid node, integrates the divided packets to undergo the distribution process, adjusts the packet transmission rate of the node based on the level of the congestion, and transmits the packets.

Further another aspect of the present invention is to provide a system and method for controlling grid network congestion that observes grid node information, such as available bandwidth, size of storage queue and channel idle time, etc., stores them in a database, and provides node-related information necessary for packet scheduling and node management.

Still another aspect of the present invention is to provide a system and method for controlling grid network congestion that measures unique availabilities of respective nodes to which the dynamic workload and available bandwidth are reflected in consideration of the nature of the grid network, predicts the average availability which alters according to time and load and sets the congestion area, thereby efficiently detecting and avoiding congestion.

In accordance with an exemplary embodiment of the present invention, a system for controlling congestion in a grid network is provided. The system includes a node managing unit for collecting node status information from grid nodes and for providing the node status information in response to a message for requesting node information, a prediction unit for calculating node availabilities of the respective grid nodes, based on the node status information transmitted from the node managing unit, and for predicting the average node availability of all the grid nodes, a packet adjusting unit for setting a congestion area based on the average anode availability transmitted from the prediction unit and for allocating packets according to estimated congestion levels of the respective grid nodes, and a grid intermediary for searching for available grid nodes in the grid network, for dividing data transmitted from a grid application program into the packets to transmit them to the packet adjusting unit, and for collecting the packets processed by the packet adjusting unit to convert them into result data.

In accordance with another exemplary embodiment of the present invention, a method for controlling congestion in a grid network configured to include a grid intermediary, a packet adjusting unit, a node managing unit, and a prediction unit is provided. The method includes by the node managing unit, collecting status information from respective grid nodes in each time period, receiving a message for requesting node information from the packet adjusting unit or the prediction unit, and transmitting a node information list including the status information, by the prediction unit, calculating node availabilities of the respective grid nodes based on the node information list, and predicting the average node availability of all the grid nodes using the second order exponential smoothing, and by the packet adjusting unit, setting a congestion area based on the average node availability transmitted from the prediction unit, estimating congestion levels of the respective grid nodes to accord packet allocation priority and to sort a node list, and sequentially allocating divided packets according to the node list.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and other advantages of certain exemplary embodiments of the present invention will become more apparent from the following detailed description in conjunction with the accompanying drawings, in which:

FIG. 1 is a schematic block diagram illustrating a system for controlling congestion in a grid network according to an exemplary embodiment of the present invention;

FIG. 2 is a flowchart describing a method for controlling congestion in a grid network according to an exemplary embodiment of the present invention;

FIG. 3 is a flowchart describing the information request information reception, and information transmission in the method for controlling congestion in a grid network according to an exemplary embodiment of the present invention;

FIG. 4 is a flowchart describing the node availability measurement and average node availability prediction in the method for controlling congestion in a grid network according to an exemplary embodiment of the present invention;

FIG. 5 is a flowchart describing the congestion area setting and packet allocation in the method for controlling congestion in a grid network according to an exemplary embodiment of the present invention;

FIG. 6 is a flowchart describing a process for according packet allocation priority in a method for controlling congestion in a grid network according to an exemplary embodiment of the present invention; and

FIG. 7 is a flowchart describing a process for sorting the node list in a method for controlling congestion in a grid network according to an exemplary embodiment of the present invention.

Throughout the drawings, like reference numerals will be understood to refer to like parts, components and structures.

### BRIEF DESCRIPTION OF SYMBOLS IN THE DRAWINGS

100: grid intermediary
110: work requesting module
120: result producing module
130: grid registry
200: packet adjusting unit
210: congestion area setting module
220: packet transmitting module
230: result transmitting module
300: node managing unit
310: information requesting module
320: information receiving module
330: information transmitting module
340: grid node database
400: prediction unit
410: list requesting module
420: availability calculating module
430: availability predicting module

### DETAILED DESCRIPTION OF EXEMPLARY EMBODIMENTS

The following description with reference to the accompanying drawings is provided to assist in a comprehensive understanding of exemplary embodiments to the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

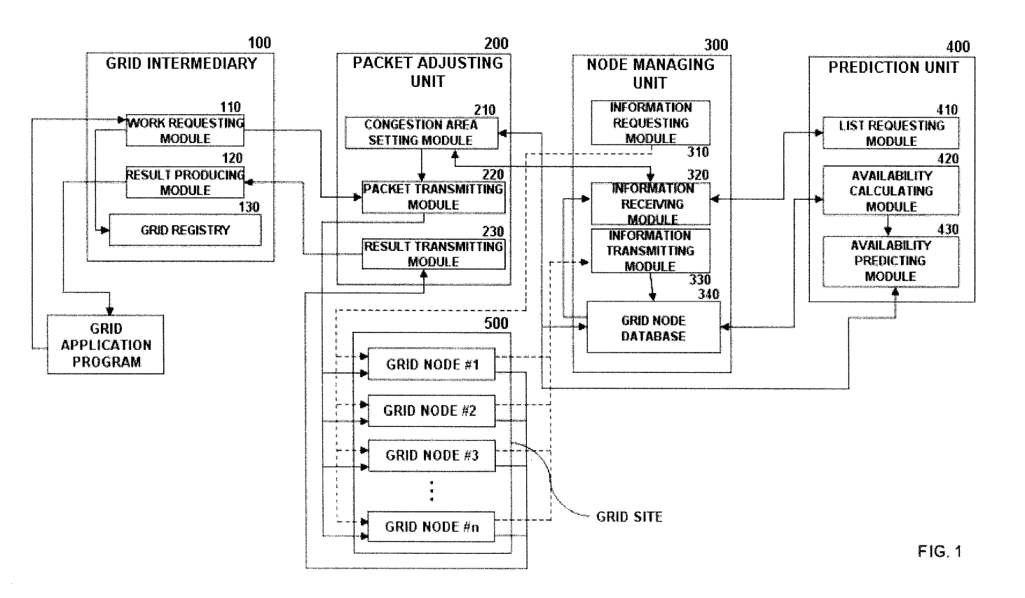

FIG. 1 is a schematic block diagram illustrating a system for controlling congestion in a grid network according to an exemplary embodiment of the present invention.

As shown in FIG. 1, the grid network congestion control system is configured to include a grid intermediary that divides data into sub-packets in response to a data process request received from a grid user (grid application program) and collects processed packets to convert them into result data, a packet adjusting unit that estimates the congestion level of grid nodes based on the congestion area to thus accord priority to the grid nodes, and then allocates the packets received from the grid intermediary a node managing unit that provides the node status information for packet allocation and node management, and a prediction unit that predicts an average node availability of all the grid nodes based on the node information and estimates the congestion area.

In an exemplary embodiment of the present application, a “grid node” is referred to as a node that has a processor and a memory, etc. and is an element connected as part of a grid network.

When a grid user requests to process a large amount of data, the grid intermediary 100 searches for grid nodes capable of processing the data.

The grid intermediary 100 transmits packets to the packet adjusting unit 200 of a grid site where the searched grid node is located and collects processed packets to generate result data. To this end, the grid intermediary 100 is configured to include a work requesting module 110, a result producing module 120, and a grid registry 130. The grid site represents a set of grid nodes.

The grid registry 130 registers and searches for all grid nodes connected to the grid network.

The work requesting module 110 receives a large amount of data from the grid user, divides corresponding data into packets, checks the grid registry 130 to search for a grid node capable of calculating data, and transmits the packets to the packet adjusting unit of the grid site including the searched grid node.

The result producing module 120 collects processed packets, converts the format of the processed packets into the format requested by the grid application program to accordingly generate result data, and then transmits the result data to the grid application program.

The node managing unit 300 is connected to the grid nodes. The node managing unit 300 serves to monitor the grid nodes and extracts the status information about the respective grid nodes to provide the node information. To this end, the node managing unit 300 is configured to include an information requesting module 310, an information receiving module 320, an information transmitting module 330, and a grid node database 340.

The information requesting module 310 transmits a message for requesting status information to the grid nodes at certain time intervals. The information receiving module 320 collects result messages from respective grid nodes that receive the request message and stores the result messages in the grid node database 340. Here, the result messages transmitted from the respective grid nodes may be in an XML format. Also, the information transmitting module 330 transmits node status information to the packet adjusting unit 200 or the prediction unit 400 in response to a message requesting the node information.

The prediction unit 400 measures the node availabilities of the respective grid nodes and predicts the average node availability of all grid nodes, as a reference parameter for setting a congestion area, using the second-order exponential smoothing-based prediction method. To this end, the prediction unit 400 is configured to include a list requesting module 410, an availability calculating module 420, and an availability predicting module 430.

The list requesting module 410 requests and receives the node information list from the node managing unit 300, which is used as basic data for calculating and predicting the node availability. The availability calculating module 420 calculates the node availabilities of the respective grid nodes based on the node information list, and stores them again in the grid node database 340 of the node managing unit 410. The availability predicting module 430 measures the average of the node availabilities calculated at the current time point and predicts the average node availability using the second-order exponential smoothing, based on old data and current data.

The packet adjusting unit 200 stores packets transmitted from the work requesting module 110 in a queue and sets the congestion area based on the average node availability received from the prediction unit 400.

The packet adjusting unit 200 requests node status information from the node managing unit 300 and receives the node information list from the node managing unit 300. The packet adjusting unit 200 estimates the congestion levels of the respective nodes according to the node information list and the average node availability and then accords the packet allocation priority. The packet adjusting unit 200 transmits the packets to the respective grid nodes according to the packet allocation priority, stores the packets processed by the grid nodes in an output queue, and then transmits them to the result producing module 120 of the grid intermediary 100.

To this end, the packet adjusting unit 200 is configured to include a congestion area setting module 210, a packet transmitting module 220, and a result transmitting module 230.

The congestion area setting module 210 serves as the primary element of the network congestion control system and enables the congestion area to be estimated. The congestion area setting module 210 sets a congestion area, based on the average node availability transmitted from the prediction unit 400.

The congestion area setting module 210 loads node information from the grid node database 330, estimates the congestion levels of the respective nodes, and accords the packet allocation priority. The packet transmitting module 220 includes an input queue for storing packets. The packet transmitting module 220 stores the divided packets transmitted from the work requesting module 110 in the input queue. The packet transmitting module 220 allocates the packets stored in the input queue to the respective grid nodes, in order, according to the packet allocation priority set by the congestion area setting module 210.

The result transmitting module 230 includes an output queue for storing packets. The result transmitting module 230 receives the packets processed by the respective grid nodes and stores them in the output queue. After the data has been processed into packets, the result transmitting module 230 sequentially transmits the packets, stored in the output queue, to the result producing module 120.

The following is a description of the operation of the grid network congestion control system as described above, and of a method for controlling congestion in a grid network, with reference to the relevant diagrams.

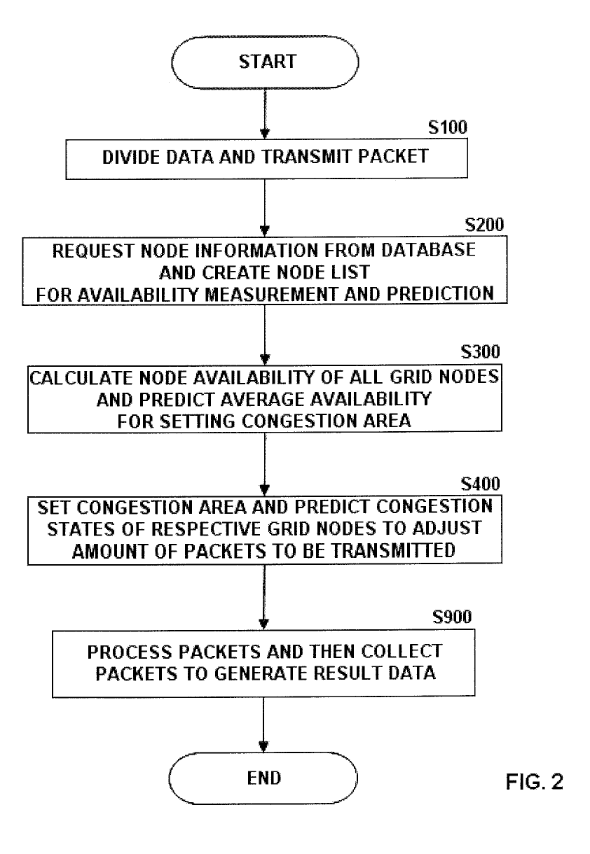

FIG. 2 is a flowchart describing a method for controlling congestion in a grid network according to an exemplary embodiment of the present invention. First, the grid intermediary 100 searches for available grid nodes, divides data received from the grid application program into packets, and transmits the divided packets to the packet adjusting unit 200 (S100).

The node managing unit 300 collects status information from respective grid nodes each time period. If the node managing unit 300 receives a message requesting node information from the packet adjusting unit 200 or the prediction unit 400, it transmits a node information list including the status information thereto (S200).

The prediction unit 400 calculates the node availabilities of the respective grid nodes based on the node information list and then predicts the average node availability of all grid nodes using the second-order exponential smoothing (S300).

The packet adjusting unit 200 sets a congestion area based on the average node availability received from the prediction unit 400, estimates the congestion levels of the respective nodes to accord packet allocation priority and to sort node lists, and then sequentially allocates the divided packets according to the node lists (S400).

The grid node intermediary 100 collects the packets, processed by the respective grid nodes, from the packet adjusting unit 200 and generates result data based on the collected packets (S900).

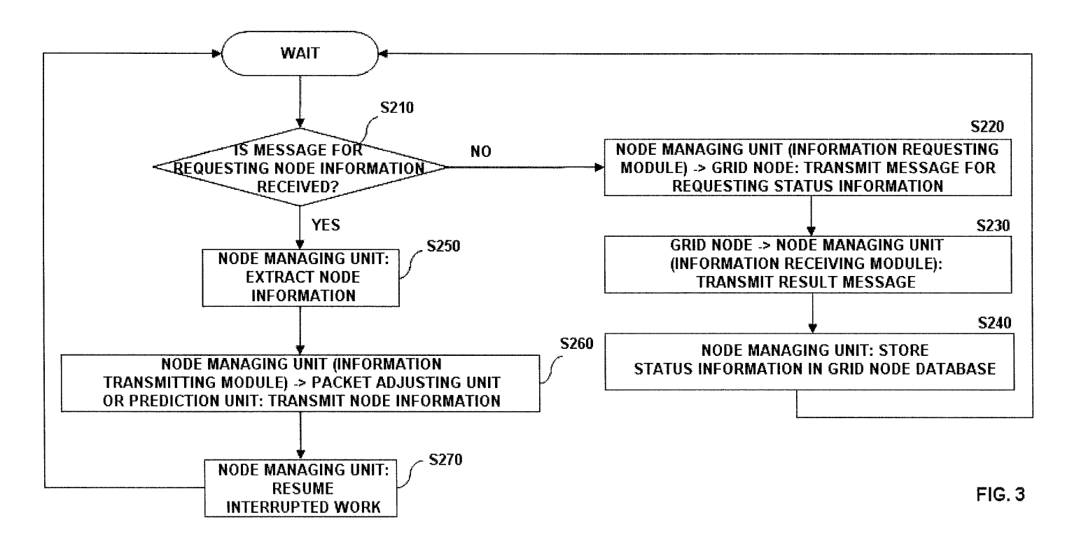

FIG. 3 is a flowchart describing information request, information reception, and information transmission in a method for controlling congestion in a grid network according to an exemplary embodiment of the present invention. That is. FIG. 3 is a flowchart describing step S200 of FIG. 2 in detail.

The node managing unit 300 determines whether to receive a node information request message from the packet adjusting unit 200 or the prediction unit 400 (S210).

If the node managing unit 300 does not receive a node information request message at step S210, the information requesting module 310 transmits an inquiry message in an XML format to the respective grid nodes to collect status information about the nodes, at certain time intervals (S220).

The respective grid nodes having received the inquiry message prepare result messages responsive to the inquiry message, and transmit them to the node managing unit 300 (i.e. the information receiving module 320) (S230).

The information receiving module 320 stores the result messages relating to the status information received from the grid nodes in the grid node database 340 (S240).

On the contrary, if the node managing unit 300 receives a request message relating to node information from the packet adjusting unit 200 or the prediction unit 400 at step S210, the node managing unit 300 interrupts its current job and extracts node status information from the grid node database 340 (S250).

The information transmitting module 330 transmits the extracted node status information about the respective nodes, in a list to the packet adjusting unit 200 or the prediction unit 400 (S260).

After the node information list has been transmitted, the node managing unit 300 resumes the interrupted job (S270).

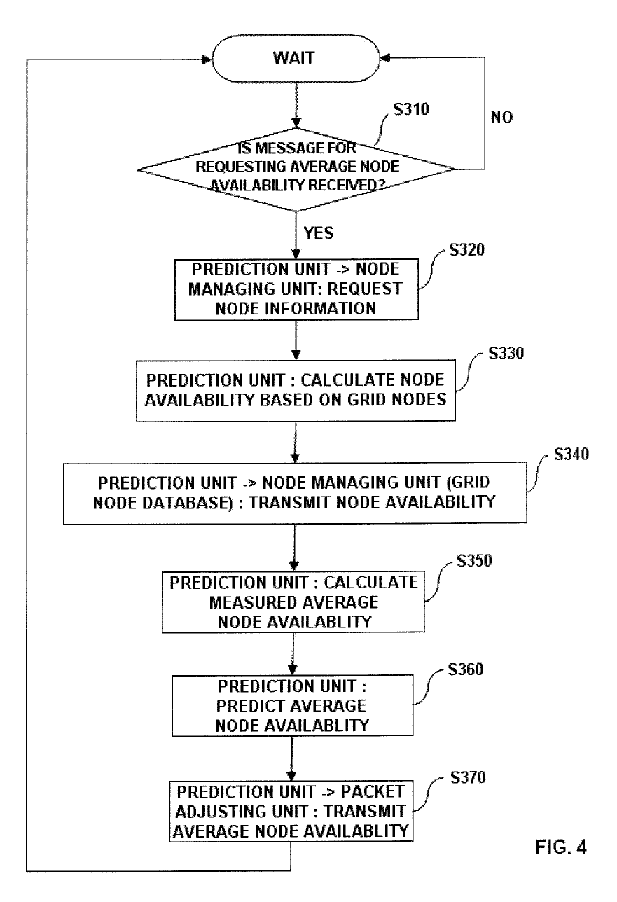

FIG. 4 is a flowchart describing node availability measurement and average node availability prediction in a method for controlling congestion in a grid network according to an exemplary embodiment of the present invention. That is, FIG. 4 is a flowchart describing step S300 of FIG. 2 in detail.

The list requesting module 410 checks whether to receive a request message of the average node availability from the congestion area setting module 210 of the packet adjusting unit 200 (S310).

If the list requesting module 410 receives the request of the average node availability at stet S310, it requests and receives the node information list, stored in the grid node database 340, from the node managing unit 300 (S320).

The availability calculating module 420 calculates the node availabilities of the respective grid nodes based on the node information list using the following Equation (1) (S330).

$$Av = ( {T}_{w} \times {B}_{w} \times {Q}_{a} ) / T \\ where \\ {B}_{w} = \frac{1}{m} {\sum }_{i = 1}^{m} {P}_{s} ( {Ta}_{i} - {Ts}_{i} ) \\ and \\ {Q}_{a} = 1 - ( {Q}_{u} / {Q}_{t} ) . \qquad ( 1 )$$

The variables in Equation 1 are defined as follows:

Av: the node availability of a grid node

T: the observation time

T_{w}: the channel wait time during the observation time. T

B_{w}: the average bandwidth of the grid nodes

Qₐ: the queue size available by the grid node

m: the number of paths capable of transmitting packets from a transmission node (e.g. a packet adjusting unit) to a receiving node (e.g. a grid node)

Pₛ: the general packet size

i: the index of the packet transmission path

Tₐ: the time period that a receiver receives packets through the i-th path

Tₛ: the time period that a transmitter transmits packets through the i-th path

Qₜ: the total queue size of a grid node

Qᵤ: the size of queues in use, of the total queues

Referring to FIG. 4, the prediction unit 400 transmits the calculated node availability to the node managing unit 300 and then stores it again in the grid node database 340 (S340).

After that, the availability prediction module 430 of the prediction unit 400 calculates the average node availability of all grid nodes at the current time point (S350), as in the following Equation (2).

$$AVG = \frac{1}{n} {\sum }_{i = 1}^{n} Avi \qquad ( 2 )$$

The variables in Equation (2) are defined as follows:

AVG: the average node availability

Av: the node availability of a grid node

i: the index of a grid node

n: the number of total grid nodes

The average node availability calculated by Equation (2) is referred to as time series data that are varied according to elapsed time and workload.

If the average node availability is calculated each observation time point, the reference value of a congestion area by variables, such as workload or bandwidth, is changed so large to cause a problem: although a grid node that does not cause congestion at the current time point, the grid node may cause congestion at the next observation time point.

The basic congestion control scheme takes old data related to congestion generation into consideration to prevent the same congestion from reoccurring in the near future.

Therefore, the availability prediction module 430 predicts the average node availability at each observation time point using the second-order exponential smoothing (S360), as in the following Equation (3).

$${FT}_{t + 1} = ( 2 + \frac{α}{1 - α} ) {F}_{t} - ( 1 + \frac{α}{1 - α} ) {T}_{t} \\ where \\ {F}_{t} = α {D}_{t} + ( 1 - α ) {F}_{t - 1} \\ and \\ {T}_{t} = α {F}_{t} + ( 1 - α ) {T}_{t - 1} . \qquad ( 3 )$$

The variables in Equation 3 are defined as follows:

FT: the estimated average node availability

t: the current observation time point

t+1: the next observation time point

D: the measured average node availability calculated through Equation (2)

α: the smoothing constant for according a weight value to old data and current data, 0<α<1

F: the prediction variable for the first-order exponential smoothing

T: the doubling-smoothed statistic

After that, the prediction unit 400 transmits the estimated average node availability to the congestion area setting module 210 using Equation (3) and enters a wait state (S370).

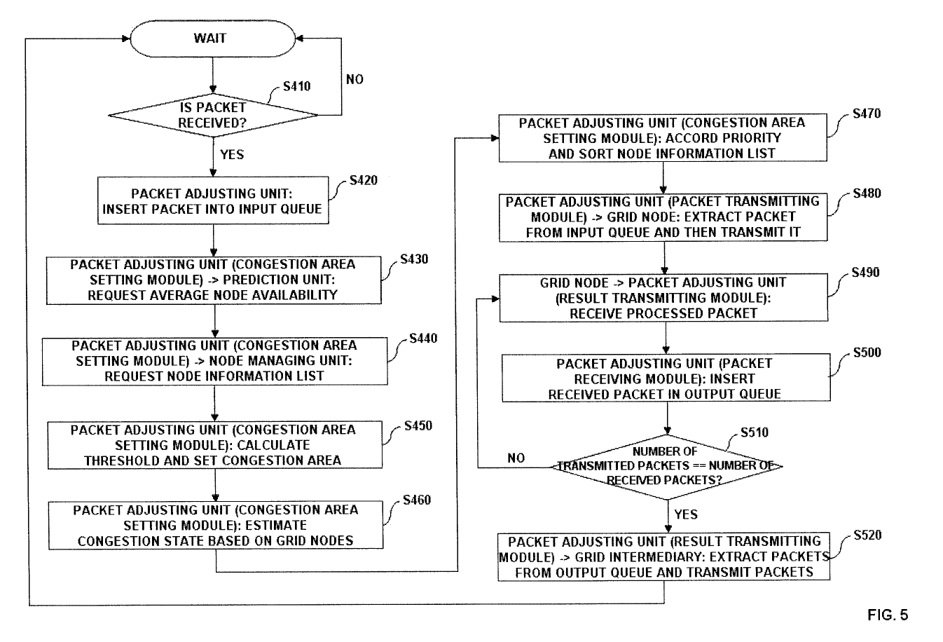

FIG. 5 is a flowchart describing congestion area setting and packet allocation in a method for controlling congestion in a grid network according to an exemplary embodiment of the present invention. That is, FIG. 5 is a flowchart describing step S400 of FIG. 2 in detail.

First, the packet transmitting module 220 receives packets from the work requesting module 110 (S410).

The packet adjusting unit 200 inqueues the received packets in order in the input queue (S420).

The congestion area setting module 210 requests and receives the average node availability used as the reference parameter, for setting a congestion area from the prediction unit 400 (S430).

When the congestion area setting module 210 requests the node information list, which includes node information about the respective nodes from the node managing unit 300, the node managing unit 300 extracts the node information list from the grid node database 330 and transmits it to the congestion area setting module 210 (S440).

The congestion area setting module 210 calculates the maximum threshold and the minimum threshold of the congestion area using the average node availability and the information list of the respective nodes, as per the following Equation (4), and then sets the congestion area (S450).

$${Max}_{th} = \frac{1}{{n}_{1}} {\sum }_{i = 1}^{{n}_{1}} ( {Ra}_{i} - {E}_{avg} ) \\ and \\ {Min}_{th} = \frac{1}{{n}_{2}} {\sum }_{i = 1}^{{n}_{2}} ( {E}_{avg} - {Ra}_{i} ) \qquad ( 4 )$$

The variables in Equation 4 are defined as follows:

Maxₜₕ: the maximum threshold

Minₜₕ: the minimum threshold

Ra: the node availability of respective grid nodes

E_{avg}: the estimated average node availability transmitted from the prediction unit

i: the index of a grid node

n₁: the number of grid nodes having the node availability equal to and greater than the average node availability

n₂: the number of grid nodes having the node availability equal to and less than the average node availability

The congestion area classifies the congestion state into three levels, red, green, and yellow levels. The red level represents a case where the node availability of a grid node is less than the minimum threshold, Ra<Minₜₕ, and means that the grid node has a high probability of congestion occurrence and thus a high probability of packet loss and packet delay.

The green level represents a case where the node availability is between the maximum threshold and the minimum threshold, Minₜₕ≦Ra≦Maxₜₕ, and means that a proper amount of packets are allocated and accordingly the packet process rate and node use rate are stably maintained.

The yellow level represents a case where the node availability exceeds the maximum threshold, Maxₜₕ<Ra. For example, since the grid node of the yellow level reduces the use bandwidth and the node use rate of all grid networks, the yellow level means that the allocation amount of packets must be increased to adjust the node availability of a corresponding grid node to a proper level.

The congestion area setting module 210 estimates congestion states of the respective grid nodes based on the congestion area (S460).

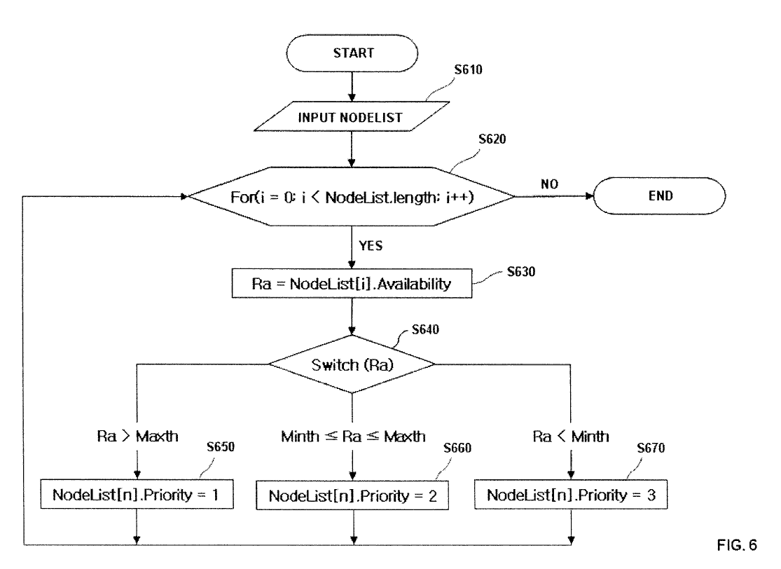

After that, the packet allocation priority is accorded to the respective grid nodes according to the congestion states (S470), which will be described below with reference to the flowchart of FIG. 6.

FIG. 6 is a flowchart describing a process for according the packet allocation priority in a method for controlling congestion in a grid network according to an exemplary embodiment of the present invention.

First, the variables described in FIG. 6 are defined as follows:

NodeList: an array type list including status information about a grid node

Priority: the priority according to the congestion state of a grid node

length: the list length

i: the index used for list search

Maxₜₕ: the maximum threshold

Minₜₕ: the minimum threshold

Ra: the node availability of the respective grid nodes

Referring to FIG. 6, the packet adjusting unit 200 requests the node information from the grid node database 330 and receives it in a list form from the grid node database 330 (S610).

After that, the packet adjusting unit 200 compares the node availability of the respective grid nodes with the maximum threshold or the minimum threshold to accord the priority according to the congestion states of the respective grid nodes (S620˜S640). If the congestion state is at the yellow level, the priority becomes 1 (S650). If the congestion state is at the green level, the priority becomes 2 (S660). If the congestion state is at the red level, the priority becomes 3 (S670).

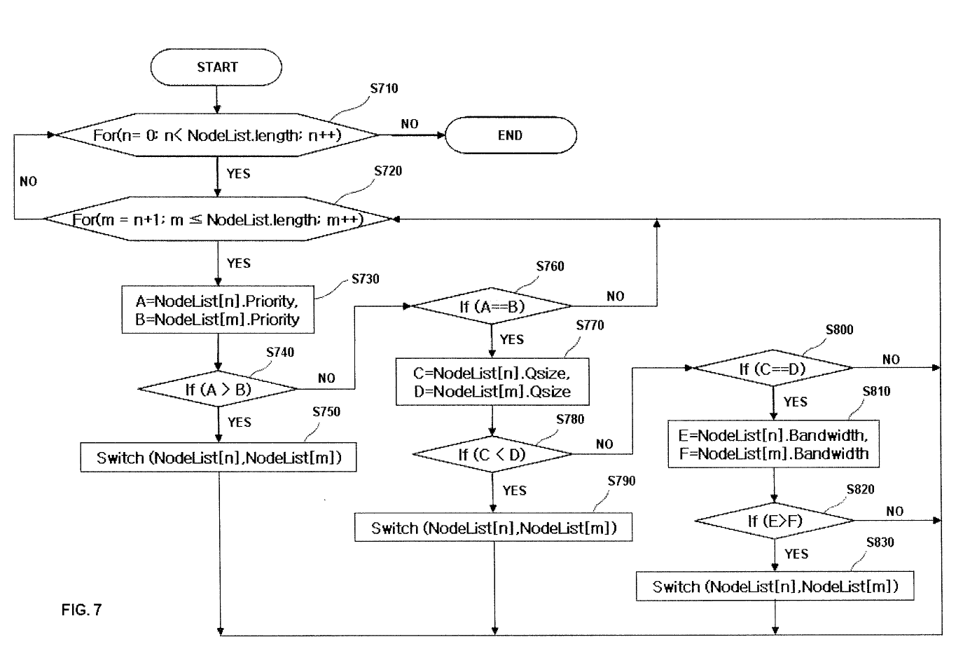

Also, the congestion area setting module 210 of the packet adjusting unit 200 sorts the node lists to allocate packets (S470), which will be described below with reference to FIG. 7.

FIG. 7 is a flowchart describing a process for sorting the node lists in a method for controlling congestion in a grid network according to an exemplary embodiment of the present invention.

First, the variables described in FIG. 7 are defined as follows:

NodeList: the array type list including status information about a grid node

length: the list length

n, m: the index used for list search

Priority: the priority allocated to a grid node

Qsize: the size of an available queue possessed by a grid node

Bandwidth: the minimum bandwidth of an available path possessed by a grid node

Switch: the function exchanging positions between items 1 and 2 in the node list

Referring to FIG. 7, the node lists are sorted based on the priority, the queue size, and the bandwidth.

The congestion area setting module 210 sorts the node lists, in ascending order, based on the priority accorded to the respective grid nodes using the process of FIG. 6 (S710˜S830). In particular, if a plurality of grid nodes has the same priority (S760), the node whose available queue size is relatively large is located at the upper index (S760˜S790). Further, if a plurality of grid nodes has the same queue size as well as the same priority (S800), the node that uses a lower bandwidth is located at the upper index (S800˜S830).

Referring to FIG. 5 back, the pack transmitting module 220 of the packet adjusting unit 200 dequeues packets from the input queue, one by one, and transmits the packets to the grid nodes registered in the sorted node list from the highest index to the lowest index in order (S480). Here, the packets are not allocated to the grid nodes whose priority is 3, i.e. those which are at the red level.

The result transmitting module 230 receives processed packets from the grid nodes and enqueues them in the output queue (S490˜S500).

When all packets have arrived, the result transmitting module 230 dequeues the packets stored in the output queue 231 and transmits them to the result producing module 120 of the grid intermediary 100 (S510˜S520).

As is apparent from the above description, the present invention provides a system and method for controlling congestion in a grid network that calculates and predicts node availability reflecting a variety of parameters, such as bandwidth, queue size, and channel wait time, and thus detects and controls congestion in a network more efficiently and precisely, thereby transmitting data through the network in a grid computing environment more efficiently and stably.

Also, the system and method for controlling congestion in a grid network, according to the present invention, set a congestion area, estimate a congestion state of respective nodes, detect nodes in congestion and restrict the transmission amount of packets, thereby reducing the packet loss.

Furthermore, the system and method for controlling congestion in a grid network, according to the present invention, control the transmission amount of packets according to the congestion state of the nodes so that: the processed amount of packets and the use rate of grid nodes are increased, network delays are reduced, and Quality of Service (QoS) is improved.

While the present invention has been described with reference to certain exemplary embodiments thereof, those skilled in the art will appreciate that various modifications, additions and substitutions are possible, without departing from the scope and spirit of the invention as defined by the appended claims and their equivalents.

What is claimed is:

1. A system for controlling congestion in a grid network comprising:
a node managing unit for collecting node status information from grid nodes and for providing the node status information in response to a message for requesting node information;
a prediction unit for calculating node availabilities of the respective grid nodes, based on the node status information transmitted from the node managing unit, and for predicting the average node availability of all the grid nodes;
a packet adjusting unit for setting a congestion area based on the average anode availability transmitted from the prediction unit and for allocating packets according to estimated congestion levels of the respective grid nodes; and
a grid intermediary for searching for available grid nodes in the grid network, for dividing data transmitted from a grid application program into the packets to transmit them to the packet adjusting unit, and for collecting the packets processed by the packet adjusting unit to convert them into result data.

2. The system of claim 1, wherein the grid intermediary comprises:
a grid registry for registering and for searching for all grid nodes connected to the grid network;
a work requesting module for dividing the data transmitted from the grid application program into packets and for searching for the grid nodes registered in the grid registry to manage grid nodes that can process data; and
a result producing module for collecting the packets processed by the packet adjusting unit and for converting them into data whose format is requested by the grid application program.

3. The system of claim 3, wherein the node managing unit comprises:
an information requesting module for transmitting a message for requesting current status information to the grid nodes at certain time intervals;
an information receiving module for receiving message relating to the current status information from the grid nodes;
a grid node database for storing the status information about the grid nodes; and
an information transmitting module for receiving a message for requesting node information from the packet adjusting unit or the prediction unit and for transmitting a node information list including the node status information stored in the grid node database to the packet adjusting unit or the prediction unit.

4. The system of claim 1, wherein the prediction unit comprises:
a list requesting module for requesting a node information list necessary for calculating and for predicting the node availabilities from the node managing unit;
an availability calculating module for the node availabilities of the respective nodes based on the node information list; and
an availability prediction module for calculating the average of the node availabilities and for predicting an average node availability using the second order exponential smoothing.

5. The system of claim, wherein the packet adjusting unit comprises:
a congestion area setting module for setting a congestion area based on the average node availability transmitted from the prediction unit, for loading the node information from the node managing unit, for estimating congestion levels of the respective nodes, and for arranging a node list for packet transmission;
a packet transmitting module for storing the packets transmitted from the grid intermediary in a queue and for sequentially transmitting the stored packets to the respective grid nodes according to the sequence of the sorted node list; and
a result transmitting module for storing the processed packets transmitted from the grid nodes in a queue and transmitting the packets to the grid intermediary when corresponding data has been processed to the packets.

6. A method for controlling congestion in a grid network, the method comprising:
by a node managing unit, collecting status information from respective grid nodes in each time period, receiving a message for requesting node information from a packet adjusting unit or a prediction unit, and transmitting a node information list including the status information;
by the prediction unit, calculating node availabilities of the respective grid nodes based on the node information list, and predicting the average node availability of all the grid nodes using the second order exponential smoothing; and
by the packet adjusting unit, setting a congestion area based on the average node availability transmitted from the prediction unit, estimating congestion levels of the respective grid nodes to accord packet allocation priority and to sort a node list, and sequentially allocating divided packets according to the node list.

7. The method of claim 6, further comprising:
by a grid intermediary, searching for available grid nodes, dividing data transmitted from a grid application program into packets, and transmitting the divided packets to the packet adjusting unit.

8. The method of claim 6, further comprising:
by the grid intermediary, collecting processed packets from the respective grid nodes and generating result data based on the collected packets.

9. The method of claim 6, wherein the collection, reception, and transmission of the node managing unit comprises:
transmitting a message for requesting status information to the respective grid nodes at certain time intervals;
receiving result messages responding to the message for requesting status information from the respective grid nodes;
storing the result messages in a grid node database;
if a message for requesting node information is received from the packet adjusting unit or the prediction unit, interrupting pending wok, and extracting the node information from the grid node database;
transmitting the extracted information about the respective grid nodes, in a list, to the packet adjusting unit or the prediction unit; and
resuming the interrupted work.

10. The method of claim 6, wherein the calculation and prediction of the prediction unit comprises:
in a wait state, receiving a request message from the packet adjusting unit and requesting a node information list from the node managing unit;
calculating node availabilities of the respective grid nodes based on the node information list transmitted from the node managing unit,
re-storing the calculated node availabilities in a grid node database;
calculating the average node availability of all the grid nodes at the current time point;
predicting the average node availability of all the grid nodes using the second order exponential smoothing; and
transmitting the predicted average node availability to the packet adjusting unit and changing its state to the wait state.

11. The method of claim 6, wherein the setting, estimation and allocation of the packet adjusting unit comprises:
storing divided packets transmitted from the grid intermediary in order in an input queue;
requesting and receiving the average node availability from the prediction unit;
requesting and receiving a node information list including node information about the respective grid nodes from the node managing unit;
calculating the maximum threshold and the minimum threshold from the congestion area using the average node availability and the node information list,
comparing the node availabilities of the respective grid nodes with the maximum threshold and the minimum threshold, respectively, and setting the congestion area,
estimating congestion states of the respective grid nodes using the congestion area;
according the packet allocation priority according to the congestion states of the respective grid nodes;
sorting node information lists based on the packet allocation priority size and bandwidth of available queues;
extracting packets from the input queue and sequentially transmitting the node information list to the grid nodes;
receiving the processed packets from the grid nodes and storing them in an output queue; and
collecting the processed packets and transmitting them to the grid intermediary.
